(19) United States
(12) Patent Application Publication
(10) Pub. No.: US 2022/0395940 A1
(43) Pub. Date: Dec. 15, 2022

(54) APPARATUS AND METHOD TO PRESS ARTICLES ON COMPONENTS OF VEHICLE ASSEMBLY

(71) Applicant: Honda Motor Co., Ltd., Tokyo (JP)

(72) Inventors: Kaleb Wayne Stephens, Pell City, AL (US); John Michael Scelsi, Pell City, AL (US); Cody Weldon Cline, Lincoln, AL (US); Chris R Wills, Sylacauga, AL (US)

(21) Appl. No.: 17/343,415

(22) Filed: Jun. 9, 2021

(51) Int. Cl. B23P 19/04; G06K 19/07

(52) U.S. Cl. CPC B23P 19/042; G06K 19/0717; B23P 2700/07; B23P 2700/50

(57) ABSTRACT

An apparatus and method for pressing articles on components of a vehicle assembly is provided. The apparatus includes a support fixture, a driving mechanism coupled to the support fixture, and a sensor coupled to the support fixture. The apparatus detects a component that includes a receiving section and controls the sensor to determine a height of the receiving section with respect to a datum of the component, based on the detection. The apparatus computes an offset distance with respect to the determined height and actuates the driving mechanism based on the offset distance. Based on the actuation, the driving mechanism moves an actuator to a first position in proximity of the receiving section. The driving mechanism further actuates to displace the actuator from the first position to a second position, which causes the actuator to apply a force on an article, causing the article to mate with the receiving section.

### BACKGROUND

Vehicle assembly typically includes components (such as an engine head) that includes one or more receiving sections (such as valve guides). In the vehicle assembly, there are various articles (such as valve seals) that have to be applied on the receiving sections. Typically, the article may be pressed onto or coupled to the receiving section with a force. If the force is less than required, then the article may be loosely coupled with the receiving section. Whereas, if the force is more than required, then the article may be flushed with the receiving section. In both the cases, the article may not fit the receiving section, which may impact the functioning of the component or the receiving section of the component. For example, if the valve seal is not applied properly (with a required force), fluid leakage may occur which may impact the functioning of the engine head.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An exemplary aspect of the disclosure provides an apparatus. The apparatus may include a support fixture and a driving mechanism that may be coupled to the support fixture and may include an actuator. The apparatus may further include a first sensor coupled to the support fixture and control circuitry. The control circuitry may detect a first component of a vehicle assembly within a workspace of the apparatus. The first component may include at least a first receiving section. The control circuitry may control the first sensor to determine a first height of the first receiving section with respect to a datum of the first component and may compute an offset distance with respect to the determined first height of the first receiving section. Thereafter, the control circuitry may actuate the driving mechanism to move the actuator at a first position in proximity of the first receiving section, based on the computed offset distance and the determined first height. The driving mechanism may be further actuated to displace the actuator from the first position to a second position. The displacement may cause the actuator to apply a force on an article. The application of the force may cause the article to mate with the first receiving section.

Another exemplary aspect of the disclosure provides a method. The method may include detecting a first component of a vehicle assembly within a workspace of an apparatus, which may include a support fixture, a driving mechanism that may be coupled to the support fixture and may include an actuator; and a first sensor that may be coupled to the support fixture. The method may further include controlling the first sensor to determine a first height of a first receiving section of the first component with respect to a datum of the first component and computing an offset distance with respect to the determined first height of the first receiving section. The method may further include actuating the driving mechanism to move the actuator at a first position in proximity of the first receiving section, based on the computed offset distance and the determined first height. The driving mechanism may be further actuated to displace the actuator from the first position to a second position. The displacement may cause the actuator to apply a force on an article. The application of the force may cause the article to mate with the first receiving section.

Another exemplary aspect of the disclosure provides a method. The method may include detecting a first component of a vehicle assembly and controlling a first sensor to determine a first height of a first receiving section of the first component with respect to a datum of the first component. The method may further include computing an offset distance with respect to the determined first height of the first receiving section and actuating the driving mechanism which includes an actuator. The driving mechanism may be actuated to move the actuator at a first position in proximity of the first receiving section, based on the computed offset distance and the determined first height. The driving mechanism may be further actuated to displace the actuator from the first position to a second position. The displacement may cause the actuator to apply a force on an article. The application of the force may cause the article to mate with the first receiving section.

This summary is provided to introduce a selection of concepts in a simplified form that are further disclosed in the detailed description of the present disclosure. This summary is not intended to identify key or essential inventive concepts of the claimed subject matter, nor is it intended for determining the scope of the claimed subject matter.

### BRIEF DESCRIPTION OF THE DRAWINGS

FIG. 1 is a diagram that illustrates an exemplary apparatus for pressing articles on components of a vehicle assembly, in accordance with at least one embodiment of the disclosure.

FIG. 2A is a diagram that illustrates an exemplary apparatus for pressing articles on components of a vehicle assembly, in accordance with at least one embodiment of the disclosure.

FIG. 2B illustrates a graph between displacement of actuators and force applied by the actuators on articles as a result of the displacement, in accordance with at least one embodiment of the disclosure.

FIGS. 3A-3B are diagrams that collectively illustrate exemplary operations of the apparatus of FIG. 1, in accordance with an embodiment of the disclosure.

FIG. 4 is a block diagram of an exemplary apparatus for pressing articles on components of a vehicle assembly, in accordance with an embodiment of the disclosure.

FIG. 5 is a flowchart that illustrates an exemplary method to couple an article with a receiving section of a component, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may provide an apparatus, for example, an apparatus to couple an article (such as a valve seal) with a first receiving section (such as a valve guide) of a first component (such as an engine head). The apparatus may include a support fixture, a driving mechanism coupled to the support fixture, and a first sensor coupled to the support fixture. While the support fixture may facilitate a movement of the driving mechanism (e.g., a movement with multiple degrees of freedom), the support fixture may be rigidly secured to prevent any undesired movements (such as wobble or vibrations) in various operational stages of the driving mechanism or the first sensor.

In an embodiment, the apparatus may further include a detection element (such as a RFID detector) that may detect the first component based on an identification element (such as a RFID tag) associated with the first component. Based on the detection of the first component, the apparatus may control an activation of the first sensor and the driving mechanism. Based on the detection of the first component, the apparatus may control the first sensor to determine a first height of the first receiving section with respect to a datum of the first component. Based on the determination of the first height, the apparatus may identify a location of the first receiving section. Based on the identified location, the apparatus may actuate the driving mechanism to align an actuator of the driving mechanism with the location of the first receiving section. Such an alignment may be performed to correct any misalignment between the first receiving section (such as the valve guide) and the article (such as the valve seal) placed on the actuator.

The apparatus may compute an offset distance with respect to the determined first height of the first receiving section. Based on the computation of the offset distance, the apparatus may actuate the driving mechanism to rapidly move the actuator to a first position in proximity of the first receiving section. The first position of the actuator may be at the offset distance from the first receiving section, for example. Based on the movement of the actuator to the computed offset distance, the driving mechanism may be further actuated to displace the actuator from the first position to a second position. The displacement of the actuator towards the second position, may cause the actuator to apply a force, which may cause the article to mate with the first receiving section.

In an embodiment, the apparatus may further include a second sensor that may be coupled to the actuator to measure the force applied on the article based on the movement of the actuator from the first position to the second position. The apparatus may utilize such measurement of the force to determine an optimal force that may be suitable for installation of the article in the first receiving section. The apparatus may also utilize such measurement of the force to determine whether the article correctly mates with the first receiving section, as per quality requirements.

Reference will now be made in detail to specific aspects or features, examples of which are illustrated in the accompanying drawings. Wherever possible, corresponding or similar reference numbers will be used throughout the drawings to refer to the same or corresponding parts.

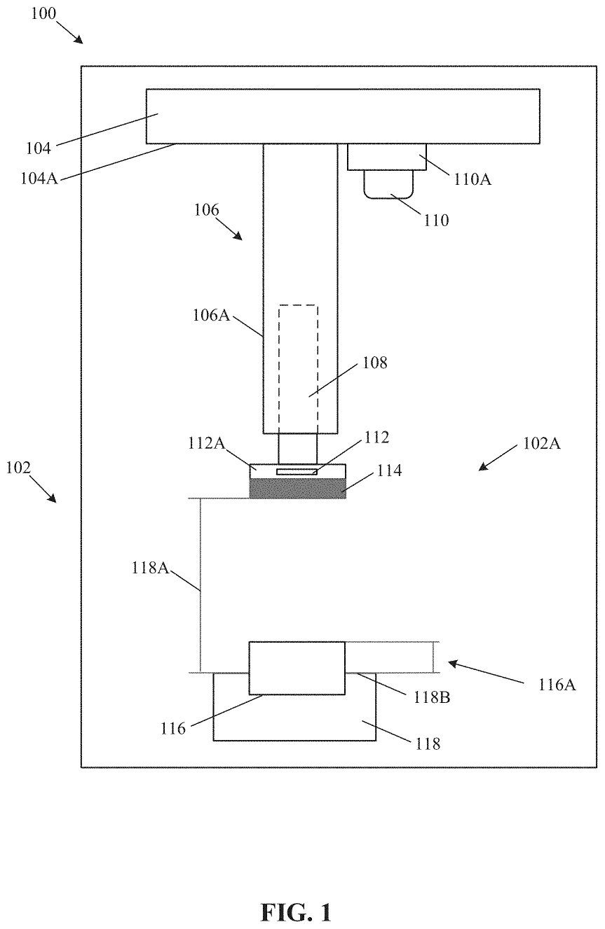

FIG. 1 is a diagram that illustrates an exemplary apparatus for pressing articles on components of a vehicle assembly, in accordance with at least one embodiment of the disclosure. With reference to FIG. 1, there is shown an exemplary view 100 of an apparatus 102. The apparatus 102 may include a support fixture 104, a driving mechanism 106 (which may be coupled to the support fixture 104 and may include an actuator 108), a first sensor 110 coupled to the support fixture 104, and a second sensor 112 coupled to the actuator 108. In an embodiment, the apparatus 102 may configure the actuator 108 to hold an article 114.

The apparatus 102 may be configured to couple or mate the article 114 with a first receiving section 116 of a first component 118. For example, the apparatus 102 may configure the driving mechanism 106 to couple or mate the article 114 (such as a valve seal) with the first receiving section 116 (such as a valve guide) of the first component 118 (such as an engine head). In an embodiment, the apparatus 102 may be disposed at an initial distance 118A from a datum 1186 of the first component 118. For example, the apparatus 102 may be disposed on a floor (such as an assembly line of a manufacturing unit) and may configure the actuator 108 to be disposed at the initial distance 118A from the first component 118.

The support fixture 104 of the apparatus 102 may be configured to hold and support components (such as the driving mechanism 106 and the first sensor 110) of the apparatus 102. For example, the support fixture 104 may include a base 104A that may be configured to hold and support the components of the apparatus 102. In an embodiment, the support fixture 104 may have a substantially rectangular structure to enhance the stability of the apparatus 102.

In an embodiment, the support fixture 104 may be disposed on a top portion of the apparatus 102 and the components (such as the driving mechanism 106 and the first sensor 110) of the apparatus 102 may be vertically supported by the base 104A of the support fixture 104. By way of example, and not limitation, the support fixture 104 may be a horizontal gantry that may be horizontally disposed in the top portion of the apparatus 102 and may be configured to moveably support the components (such as the driving mechanism 106 and the first sensor 110) of the apparatus 102. The support fixture 104 may be configured to translate at least one of: the actuator 108 or the first sensor 110 via a mechanical unit (such as a rack and pinion mechanism or other geared mechanisms), which may be associated with the support fixture 104. In another embodiment, the support fixture 104 may be vertically disposed on a side portion (not shown) of the apparatus 102 and the components (such as the driving mechanism 106 and the first sensor 110) of the apparatus 102 may be horizontally supported on the support fixture 104. For example, the support fixture 104 may be a vertical gantry that may be vertically disposed on the side portion (such as a left-side portion and/or a right-side portion) of the apparatus 102 and may be configured to moveably support the components (such as the driving mechanism 106 and the first sensor 110) of the apparatus 102. The support fixture 104 may be configured to translate at least one of the driving mechanism 106 or the first sensor 110 via a mechanical unit (such as the rack and pinion mechanism or other geared mechanisms), which may be associated with the support fixture 104 of the apparatus 102.

The driving mechanism 106 may be coupled to the support fixture 104 and may include the actuator 108, which may be configured to couple the article 114 with the first receiving section 116 of the first component 118. For example, the driving mechanism 106 may include an actuation cylinder 106A that may be configured to slidably receive the actuator 108. The apparatus 102 may control the driving mechanism 106 to control a movement of the actuator 108 from the actuation cylinder 106A to mate the article 114 with the first receiving section 116 of the first component 118. In an embodiment, the driving mechanism 106 may include the actuation cylinder 106A that may slidably activate the actuator 108. The activation may be based on at least one of an electric power supply, a pneumatic power supply, a hydraulic fluid pressure supply, or a mechanical power supply. The apparatus 102 may operate the driving mechanism 106 with or without the electric power supply. For example, for electronic actuation, the driving mechanism 106 may include a servo motor-based actuation device, a solenoid-based actuation device, and the like. Similarly, for mechanical actuation, the driving mechanism 106 may include a mechanical actuation device such as a screw jack-based actuation device.

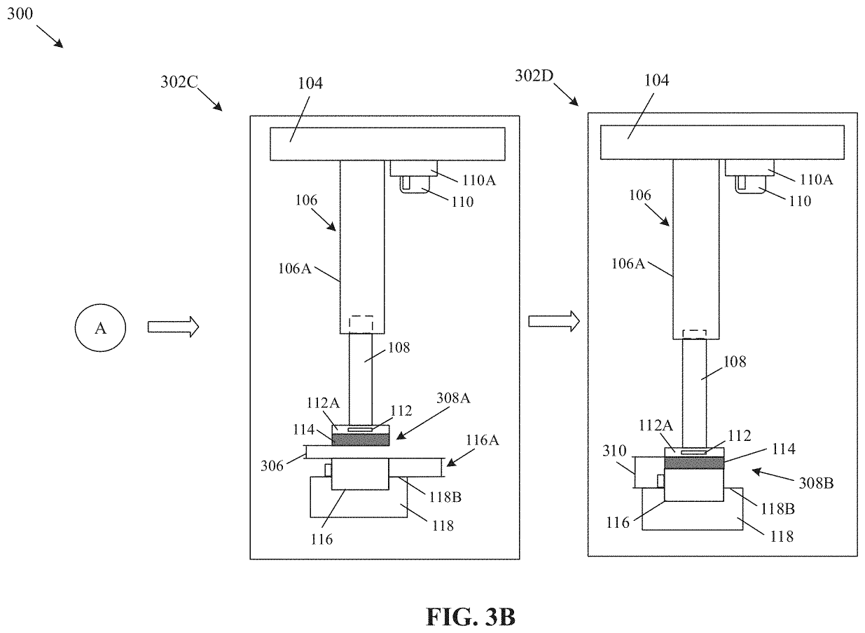

In case the base 104A of the support fixture 104 is horizontally disposed on the top portion of the apparatus 102, the actuation cylinder 106A of the driving mechanism 106 may be vertically disposed on the base 104A of the support fixture 104. For example, the actuation cylinder 106A of the driving mechanism 106 may be disposed substantially perpendicular from the base 104A of the support fixture 104. In case the base 104A of the support fixture 104 is vertically disposed (not shown) on the side portion of the apparatus 102, the actuation cylinder 106A of the driving mechanism 106 may be horizontally disposed on the base 104A of the support fixture 104. Details of the control of the driving mechanism 106 are further described, for example, in FIG. 3B.

The actuator 108 may be configured to secure the article 114 and couple the article 114 with the first receiving section 116 of the first component 118. For example, the actuator 108 may include a base to secure the article 114. Based on the movement of the actuator 108, the actuator 108 may release the secured article 114, to couple the article 114 to the first receiving section 116 of the first component 118. In another example, the article 114 may be disposed on the first receiving section 116 of the first component 118. Based on the movement of the actuator 108, the secured article 114 may be pressed to couple with the first receiving section 116 of the first component 118.

In an embodiment, the actuator 108 may have a substantially cylindrical shape with a cylindrical head on the base of the actuator 108 to secure the article 114. Such a shape of the actuator 108 and the actuation cylinder 106A may facilitate a minimal wear during the movement of the actuator 108, which may enhance a machine life of the apparatus 102. For example, the actuator 108 may be a cylindrical piston with a piston head on the base of the actuator 108, to secure the article 114 (such as the valve seal). In another embodiment, the actuator 108 may have any other shape, such as, but not limited to, a substantially square shape or a substantially polygonal shape.

In an embodiment, the actuator 108 may be slidably disposed in the actuation cylinder 106A of the driving mechanism 106. For example, the actuator 108 may be moved from the actuation cylinder 106A to couple the article 114 with the first receiving section 116 of the first component 118. Details of such movement of the actuator 108 are further described, for example, in FIG. 3B. In an embodiment, the apparatus 102 may include the first sensor 110 to determine and record the movement of the actuator 108.

The first sensor 110 may be configured to determine information associated with a first height 116A of the first receiving section 116 with respect to a datum (such as the datum 118B) of the first component 118. Examples of the first sensor 110 may include, but are not limited to, an optical sensor, an acoustic sensor, an image sensor, a laser-based sensor, a Light Detection and Ranging (LIDAR) sensor, an inductive sensor (such as a hall sensor), a tactile sensor (such as a touch probe), or a Linear Variable Differential Transformer (LVDT).

In an embodiment, the first sensor 110 may include a detection circuit (not shown) to determine the information associated with the first height 116A and to transmit such information to the apparatus 102. Such information may include, for example, a set of discrete depth or distance values associated with the first receiving section 116. The apparatus 102 may determine the first height 116A based on the determined information. Based on the determination of the first height 116A, the apparatus 102 may be configured to determine a location of the first receiving section 116. Based on the determined location, the apparatus 102 may control the driving mechanism 106 to align the actuator 108 and/or the article 114 with the location of the first receiving section 116. Such an alignment with the location of the first receiving section 116 may help to reduce any misalignment between the article 114 and the first receiving section 116. Details of the determination of the first height 116A are further described, for example in FIG. 3A.

In case the first sensor 110 is an optical sensor, the first sensor 110 may be configured to illuminate a portion (not shown) of the first receiving section 116 with light signals (in visible spectrum or invisible spectrum). The first sensor 110 may receive a reflected portion of the light signals and may determine the first height 116A by applying one or more signal processing operations on the received portion of the light signals. Examples of the optical sensor may include, but are not limited to, a Light Amplification by Stimulated Emission Radiation (LASER) sensor, an infrared sensor, a light-emitting diode (LED), a fiber optic sensor, or a photodetector. In case the first sensor 110 is an acoustic sensor, the first sensor 110 may generate an acoustic signal (audible or inaudible) that may be processed to determine information associated with the first height 116A of a portion (not shown) of the first receiving section 116. For example, the first sensor 110 may include a microphone array to record the generated acoustic signal and to measure a direction of arrival (DOA) and a depth of one or more locations associated with the first receiving section 116. Examples of the acoustic sensor may include, but are not limited to, a microphone array with a sound generation device, a directional microphone with a sound generation device, an ultrasonic sensor, a probe microphone, or a condenser microphone.

In case the first sensor 110 is an image sensor, the first sensor 110 may be configured to capture a plurality of images of the first receiving section 116 and/or a plurality of images of the portion of the datum 118B of the first component 118. The apparatus 102 may be configured to process the captured plurality of images using a suitable depth measurement method (such as a stereoscopic method) to determine the first height 116A. Examples of the image sensor may include, but not limited to, a wide-angle camera, an action camera, an event camera, a closed-circuit television (CCTV) camera, a camcorder, a digital camera, camera phones, a time-of-flight camera (ToF camera), and/or other image capture devices.

The first sensor 110 may be disposed on the base 104A of the support fixture 104, via a first support 110A. In an embodiment, the first support 110A may be fixedly coupled to the support fixture 104. In another embodiment, the first support 110A may be moveably coupled to the support fixture 104 and may configure the first sensor 110 to move along a unidirectional track or multi-axial track (not shown) present on the support fixture 104. The movement of the first sensor 110 may include a linear movement, an angular movement, or a combination thereof.

The second sensor 112 may be configured to measure a force that may be applied on the article 114 based on the movement of the actuator 108. When the actuator 108 couples the article 114 with the first receiving section 116 of the first component 118, the actuator 108 may apply a force to release the article 114 from the actuator 108 so as to couple or mate the article 114 with the first receiving section 116 of the first component 118. In this case, the apparatus 102 may configure the second sensor 112 to measure the force applied by the actuator 108.

In an embodiment, the second sensor 112 may convert the detected force to electrical signals and may transmit such electrical signals to the apparatus 102. The apparatus 102 may determine information associated with the force of the actuator 108 based on the electrical signals that may be received from the second sensor 112. The determined information may be used to determine additional information associated with lubrication between the article 114 (such as the valve seal) and the first receiving section 116 (such as the valve guide) and a fit (such as an interference fit and/or an alignment) between the article 114 (such as the valve seal) and the first receiving section 116 (such as the valve guide). Examples of the second sensor 112 may include, but are not limited to, a load cell, a strain gauge, and a Force Sensing Resistors (FSRs). In an embodiment, the second sensor 112 may be disposed on the actuator 108 via a second support 112A. The second support 112A may couple the second sensor 112 to the base of the actuator 108.

The article 114 may be an implement (such as the valve seal) that may be configured to prevent fluid leakage from the first receiving section 116 (such as the valve guide) of the first component 118 (such as the engine head). For example, the article 114 may be one of: a valve seal, a camshaft seal, a crankshaft seal, a B-cap, an injector rail, or a body bushing for a frame of a vehicle assembly. In an embodiment, the article 114 may be either disposed on the actuator 108 or disposed on the first receiving section 116 of the first component 118, based on user requirements. Selection of articles (such as the article 114) may be based on whether the first receiving section 116 is a valve guide, a cam shaft, or a crank shaft, for example. In case the first receiving section 116 is a valve guide, the selected article 114 may be a valve seal. In case the first receiving section 116 is the cam shaft, the selected article 114 may be a cam seal. In case the first receiving section 116 is the crankshaft, the selected article 114 may be a crankshaft seal.

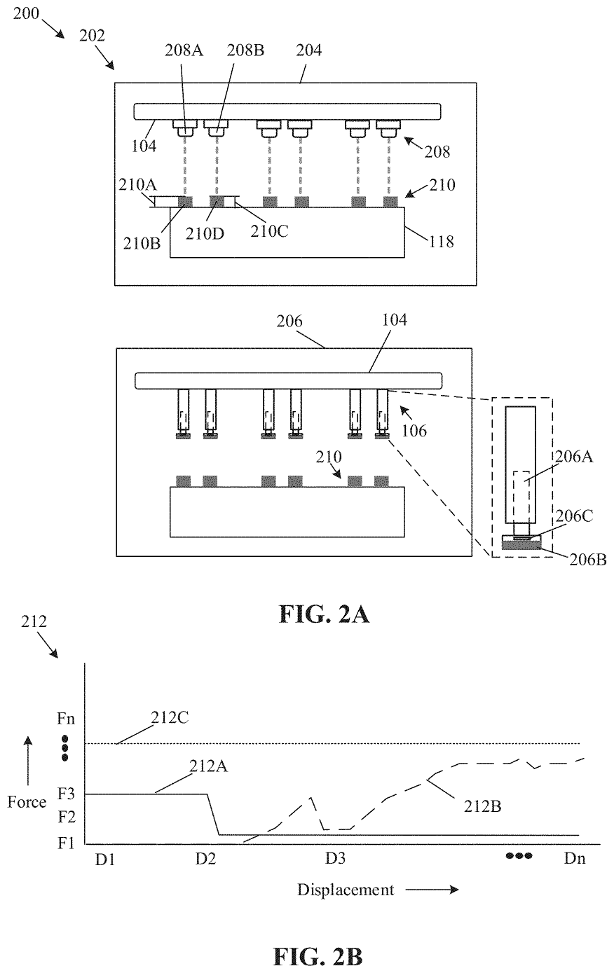

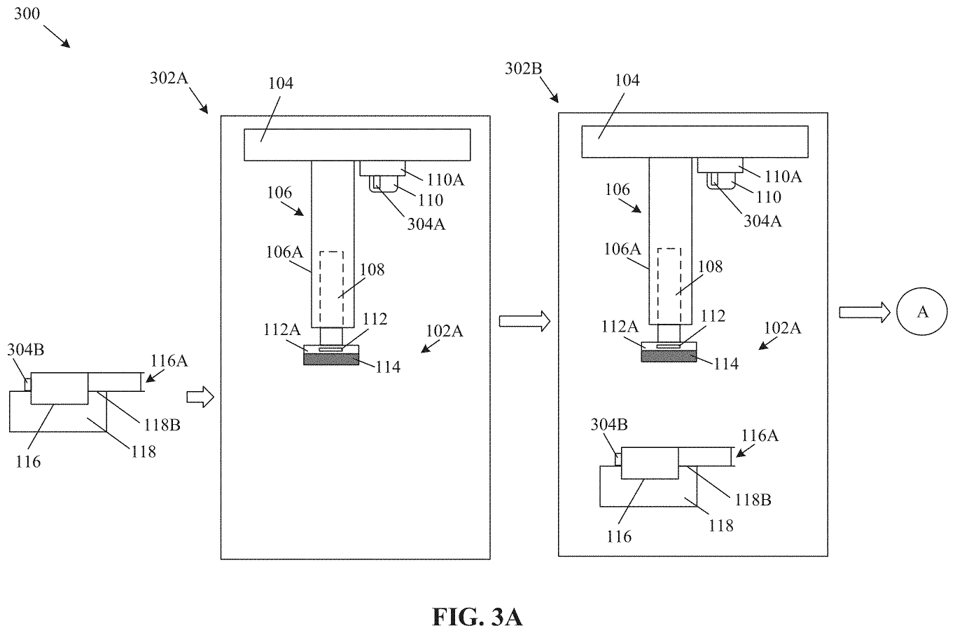

The first component 118 may be an engine head, which may include the first receiving section 116, such as the valve guide. In an embodiment, the first component 118 may include a plurality of first receiving sections (as shown in FIG. 2) that may need to be coupled with a plurality of articles (such as a plurality of valve seals). In an embodiment, based on an arrangement of the plurality first receiving sections, the first component 118 may have a plurality of configurations. Examples of the plurality of configurations of the first component 118 may include, but are not limited to, a loop-flow configuration (i.e., the plurality of first receiving sections may be disposed in a single side on the first component 118) and an inline cross-flow configuration (i.e., the plurality of first receiving sections may be disposed on opposing sides on the first component 118). Details of such receiving sections are described further, for example, in FIG. 2.

In operation, the apparatus 102 may be disposed at the initial distance 118A from the datum 118B of the first component 118, as shown in FIG. 1. When the first component 118 is disposed or received within a workspace 102A (such as a section of the assembly line) of the apparatus 102, the apparatus 102 may be configured to detect the first component 118 of a vehicle assembly (not shown). Details of the detection of the first component 118 are further explained, for example, in FIG. 3A. Based on the detection of the first component 118, the apparatus 102 may be further configured to control the first sensor 110 to determine the first height 116A of the first receiving section 116 with respect to the datum 118B of the first component 118. Details of the determination of the first height 116A are further explained, for example, in FIG. 3A.

Based on the determination of the first height 116A, the apparatus 102 may be configured to compute an offset distance (shown in FIG. 3B) with respect to the determined first height 116A of the first receiving section 116. The apparatus 102 may be further configured to actuate the driving mechanism 106 to move the actuator 108 at a first position (as shown in FIG. 3B) in proximity of the first receiving section 116, based on the computed offset distance and the determined first height 116A. When the actuator 108 reaches the first position, the apparatus 102 may further actuate the driving mechanism 106 to displace the actuator 108 from the first position to a second position (as shown in FIG. 3B). The displacement may cause the actuator 108 to apply a force on the article 114 and the application of the force may cause the article 114 to couple or mate with the first receiving section 116. As the article 114 mates or couples with the first receiving section 116, the article 114 may be disposed at a second height (as shown in FIG. 3B) from the datum 118B of the first component 118. Details of the movement of the actuator 108 from the first position to the second position are further described, for example, in FIG. 3B. In an embodiment, the actuator 108 may be further configured to couple a plurality of articles with a corresponding plurality of receiving sections (as shown in FIG. 2A) of the first component 118.

FIG. 2A is a diagram that illustrates an exemplary apparatus for pressing articles on components of a vehicle assembly, in accordance with at least one embodiment of the disclosure. FIG. 2A is explained in conjunction with elements from FIG. 1. With reference to FIG. 2A, there is shown an exemplary diagram 200 of an apparatus 202 and the first component 118 of a vehicle assembly. The apparatus 202 may be spread across one or more locations, such as a first station 204 and a second station 206 of the assembly line.

At the first station 204, the apparatus 202 may include a plurality of first sensors 208 that may be disposed on the support fixture 104. In an embodiment, each sensor of the plurality of first sensors 208 may be sequentially spaced and horizontally located on the base 104A of the support fixture 104. In an example, the sequential spacing between each sensor of the plurality of first sensors 208 may be determined based on a location of each receiving section of a plurality of first receiving sections 210 of the first component 118. In another example, the sequential spacing between each sensor of the plurality of first sensors 208 may be determined based on a location of each container (such as an engine cylinder) of a plurality of containers (not shown) of the first component 118.

In another embodiment, the apparatus 202 may control a specific number of sensors from the plurality of first sensors 208. The specific number of sensors may be controlled based on a number of first receiving sections of the first component 118. For example, if there are six receiving sections (such as valve guides) in the first component 118, then the apparatus 202 may be configured to control six sensors of the plurality of first sensors 208. Alternatively, the specific number of sensors may be controlled based on a number of each containers of the first component 118. For example, if there are six containers (such as six engine cylinders) in the first component 118 (such as the engine head), then the apparatus 202 may be configured to control six sensors of the plurality of first sensors 208. The function of each of the plurality of first sensors 208 may be same as the function of the first sensor 110, as described, for example, in FIG. 1. Therefore, the description of the plurality of first sensors 208 is omitted from the disclosure for the sake of brevity.

At the second station 206, the apparatus 202 may include a plurality of actuators 206A that may be disposed on the support fixture 104. The support fixture 104 located at the second station 206 may be same as or different from the support fixture 104 located at the first station 204. In an embodiment, each actuator (such as the actuator 108) of the plurality of actuators 206A may be sequentially spaced and horizontally located on the base 104A of the support fixture 104. The sequential spacing between each actuator of the plurality of actuators 206A may be based on the location of each receiving section of the plurality of first receiving sections 210 of the first component 118. Additionally, or alternatively, the sequential spacing between each actuator of the plurality of actuators 206A may be based on the location of each container (such as engine cylinder) of the plurality of containers of the first component 118.

In an embodiment, the apparatus 202 may control a specific number of actuators of the plurality of actuators 206A. The specific number of actuators may be controlled based on a number of first receiving sections of the first component 118. For example, if there are six receiving sections (such as valve guides) in the first component 118, then the apparatus 202 may be configured to control six actuators of the plurality of actuators 206A. Additionally, or alternatively, the specific number of actuators of the plurality of actuators 206A may be controlled based on a number of containers of the first component 118. For example, if there are six containers (such as six engine cylinders) in the first component 118 (such as the engine head), then the apparatus 202 may be configured to control six actuators of the plurality of actuators 206A. The function of each of the plurality of actuators 206A may be same as the function of the actuator 108, as described, for example, in FIG. 1. Therefore, the description of the plurality of actuators 206A is omitted from the disclosure for the sake of brevity.

In an embodiment, each actuator of the plurality of actuators 206A may be configured to hold each article of a plurality of articles 206B. The plurality of articles 206B may be same as the article 114 of FIG. 1. Therefore, a description of the plurality of articles 206B is omitted from the disclosure for the sake of brevity. In another embodiment, each actuator of the plurality of actuators 206A may be coupled to a respective second sensor of a plurality of second sensors 206C. The function of each of the plurality of second sensors 206C may be same as the function of the second sensor 112, as described, for example, in FIG. 1. Therefore, the description of the plurality of second sensors 206C is omitted from the disclosure for the sake of brevity.

In operation, at the first station 204, the apparatus 202 may calibrate the plurality of first sensors 208 so as to reset each first sensor of the plurality of first sensors 208, to a default position/orientation (such as an initial orientation and/or an initial position), based on a preset master value stored on the apparatus 202. The preset master value may be a reference or default positional value for the plurality of first sensors 208. In case each sensor of the plurality of first sensors 208 is disposed at a position/orientation that is different from the default position/orientation, the apparatus 202 may modify the position and/or the orientation of each sensor of the plurality of first sensors 208 to the default position/orientation.

Based on the calibration of the plurality of first sensors 208, the apparatus 202 may control the plurality of first sensors 208 to detect (such as via a Radio Frequency Identification (RFID) tag) the first component 118 (as shown in FIG. 3A). Based on the detection of the first component 118, the apparatus 202 may control each sensor of the plurality of first sensors 208 to determine a height of each receiving section of the plurality of first receiving sections 210 with respect to the datum 118B of the first component 118. As an example, the plurality of first sensors 208 may include a primary first sensor 208A to determine a third height 210A of a first section 210B of the plurality of first receiving sections 210. AS another example, the plurality of first sensors 208 may include a secondary first sensor 208B to determine a fourth height 210C of a second section 210D of the plurality of first receiving sections 210.

Based on the determined height (such as the third height 210A and/or the fourth height 210C) of each section (such as the first section 210B and/or the second section 210D) of the plurality of first receiving sections 210, the apparatus 202 may compute an offset distance (as shown in FIG. 3B) with respect to the determined height of each section (such as the first section 210B and/or the second section 210D) of the plurality of first receiving sections 210. In an embodiment, the apparatus 202 may compare information associated with the determined height of each section (such as the first section 210B and/or the second section 210D) of the plurality of first receiving sections 210, with information associated with a default height of each receiving sections of the first component 118, which may be stored as a preset master value on the apparatus 202. The default height may be required for the precise installation of each article on the corresponding receiving section of the plurality of first receiving sections 210 of the first component 118. Based on the comparison, the apparatus 202 may compute the offset distance for each section (such as the first section 210B and/or the second section 210D) of the plurality of first receiving sections 210 of the first component 118. Examples of the comparison of the information associated with the height of each section of the plurality of first receiving sections 210, with the information associated with the corresponding default height are presented in Table 1, as follows:

TABLE 1
Computation of the offset distance

| Location | 1a | 1b | 2a | 2b | 3a | 3b |
|---|---|---|---|---|---|---|
| Preset Height Values | 101.1 | 102.3 | 106.7 | 101.8 | 100.9 | 102.7 |
| (in mm) | | | | | | |
| Determined Height Values | 101.3 | 102.5 | 106.2 | 101.4 | 100.9 | 102.4 |
| (in mm) | | | | | | |
| Computed Offset Distance | −0.2 | −0.2 | +0.5 | +0.4 | +0.0 | +0.3 |
| (in mm) | | | | | | |

With reference to Table 1, at locations (such as 1a, 1b, 2a, 2b, 3a, or 3c) of the plurality of first receiving sections 210, there may be a corresponding preset height value (such as 101.1 mm, 102.3 mm, 106.7 mm, 101.8 mm, 100.9 mm, or 102.7 mm respectively) that may be stored as the master value in the apparatus 102. The apparatus 202 may compare information associated with the preset height values with information associated with determined height values (such as 101.3 mm, 102.5 mm, 106.2 mm, 101.4 mm, 100.9 mm, or 102.4 mm) to compute the offset distance. For example, the apparatus 202 may compare a first preset height value (i.e., 101.1 mm) at “1a” location with a first height value (i.e., 101.3 mm) at “1a” location to compute a first offset value (i.e., −0.2 mm) at “1a” location. As another example, the apparatus 202 may compare a second preset height value (i.e., 102.3 mm) at “1b” location with a second height value (i.e., 102.5 mm) at “1b” location to compute a second offset value (i.e., −0.2 mm) at “1b” location. As another example, the apparatus 202 may compare a third preset height value (i.e., 106.7 mm) at “2a” location with a third height value (i.e., 106.2 mm) at “2a” location to compute a third offset value (i.e., +0.5 mm) at “2a” location. As another example, the apparatus 202 may compare a fourth preset height value (i.e., 101.8 mm) at “2b” location with a fourth height value (i.e., 101.4 mm) at “2b” location to compute a fourth offset value (i.e., +0.4 mm) at “2b” location. As another example, the apparatus 202 may compare a fifth preset height value (i.e., 100.9 mm) at “3a” location with a fifth height value (i.e., 100.9 mm) at “3a” location, to compute a fifth offset value (i.e., 0.0 mm) at “3a” location. As another example, the apparatus 202 may compare a sixth preset height value (i.e., 102.7 mm) at “3b” location with a sixth height value (i.e., 102.4 mm) at “3b” location to compute a sixth offset value (i.e., +0.3 mm) at “3b” location.

Based on computation of the offset distance with respect to the determined height, the apparatus 202 may control a conveyer belt (not shown) of the assembly line to move the first component 118 from the first station 204 to the second station 206. In an embodiment, at the second station 206, the apparatus 202 may calibrate the plurality of actuators 206A to reset each actuator of the plurality of actuators 206A, to a default position/orientation (such as an initial orientation and/or an initial position), based on a preset master value stored on the apparatus 202. The preset master value may include information associated with a default position/orientation for the plurality of actuators 206A. In case each actuator of the plurality of actuators 206A is disposed at a different position/orientation, the apparatus 202 may modify a position and/or an orientation of each actuator of the plurality of actuators 206A, to the default positional orientation.

Upon on the calibration of the plurality of actuators 206A of the driving mechanism 106, the apparatus 102 may actuate the driving mechanism 106. The actuation of the driving mechanism 106 may move or displace each actuator of the plurality of actuators 206A at a first position (as shown in FIG. 3B) in proximity of each section of the plurality of first receiving sections 210, based on the computed offset distance and the determined first height at each section of the plurality of first receiving sections 210. The actuation of the driving mechanism 106 may further displace each actuator of the plurality of actuators 206A from the first position to a second position (as shown in FIG. 3B). The displacement (for example, a forward displacement) may cause each actuator of the plurality of actuators 206A to apply a force on a respective article of the plurality of articles 206B. The application of the force may cause on each article may cause each article of the plurality of articles 206B to mate or couple with a respective section of the plurality of first receiving sections 210.

Based on the movement of each actuator of the plurality of actuators 206A from the first position to the second position, the apparatus 202 may control each second sensor of the plurality of second sensors 206C to measure the force that may be applied on each article of the plurality of articles 206B. Based on the measured force, the apparatus 202 may determine whether or not each article of the plurality of articles 206B correctly mates with a respective section of the plurality of first receiving sections 210. The measured force may be plotted on a graph against a displacement of each actuator of the plurality of actuators 206A. An example of such a graph is provided in FIG. 2B.

FIG. 2B illustrates a graph between displacement of actuators and force applied by the actuators on articles as a result of the displacement, in accordance with at least one embodiment of the disclosure. FIG. 2B is explained in conjunction in FIGS. 1 and 2A. With reference to FIG. 2B, there is shown a graph 212, which may be used to determine whether each article of the plurality of articles 206B correctly mates with a respective section of the plurality of first receiving sections 210. In the graph 212, there is shown a plot between the displacement of each actuator of the plurality of actuators 206A along the X-axis and the measured force that may be applied on each article of the plurality of articles 206B along the Y-axis. The plot may include a measured speed curve 212A (which may be determined by a measured speed on each speed sensor of a plurality of speed sensors (not shown) associated with the apparatus 202), a measured force curve 212B (which may be determined by the measured force on each second sensor of the plurality of second sensors 206C), and a threshold force curve 212C (which may be determined based on an upper force limit that may be stored as the master value on the apparatus 202).

With reference to the measured speed curve 212A, the measurement of speed may start at a “D1” location of each actuator of the plurality of actuators 206A. In an embodiment, the “D1” location of each actuator of the plurality of actuators 206A is the initial position (as described in FIG. 1) of each actuator of the plurality of actuators 206A. In an embodiment, when each actuator of the plurality of actuators 206A moves from the “D1” location (i.e., the initial position as shown in FIG. 1) to a “D2” location (such as the first position, shown in FIG. 3B), each actuator of the plurality of actuators 206A may move at a rapid speed to improve cycle time, which may be required to mate or couple each article of the plurality of articles 206B with a respective section of the plurality of first receiving sections 210.

With reference to the measured speed curve 212A, when each actuator of the plurality of actuators 206A is about to reach the “D2” location (such as the first position, shown in FIG. 3B), it may be observed that each actuator moves at a reduced speed to improve the quality and precision of the installation of each article on a respective section of the plurality of first receiving sections 210. For example, if the first component 118 is an engine head, then the installation of the valve seal may be performed on the valve guide, without any interference or gaps between the valve seal and the valve guide.

With reference to the measured force curve 212B, it may be observed that when each actuator of the plurality of actuators 206A is displaced from the “D2” location (such as the first position as shown in FIG. 3B) to a “D3” location (such as the second position as shown in FIG. 3B), then there may be a significant spike in the measured force (which may have acted on each article of the plurality of articles 206B). The spike may indicate a rapid movement of the actuators to mate each article of the plurality of articles 206B with a respective section of the plurality of first receiving sections 210. When each actuator is about to reach the “D3” location (i.e., the second position as shown in FIG. 3B), there may be a significant decline in the measured force on each article of the plurality of articles 206B. Such a significant decline in the measured force may improve the quality and precision of the installation of the plurality of articles 206B on the corresponding plurality of first receiving sections 210.

In some instances, the measured force may have a plurality of intermittent force spikes based on a variation in the power supply to each actuator of the plurality of actuators 206A. In such cases, the threshold force curve 212C may be used to set a boundary for such plurality of intermittent force spikes so that the plotted measured force curve 212B does not exceed an upper force limit of the threshold force curve 212C. The upper force limit may allow each actuator of the plurality of actuators 206A to correctly install each article of the plurality of articles 206B on a respective section of the plurality of first receiving sections 210.

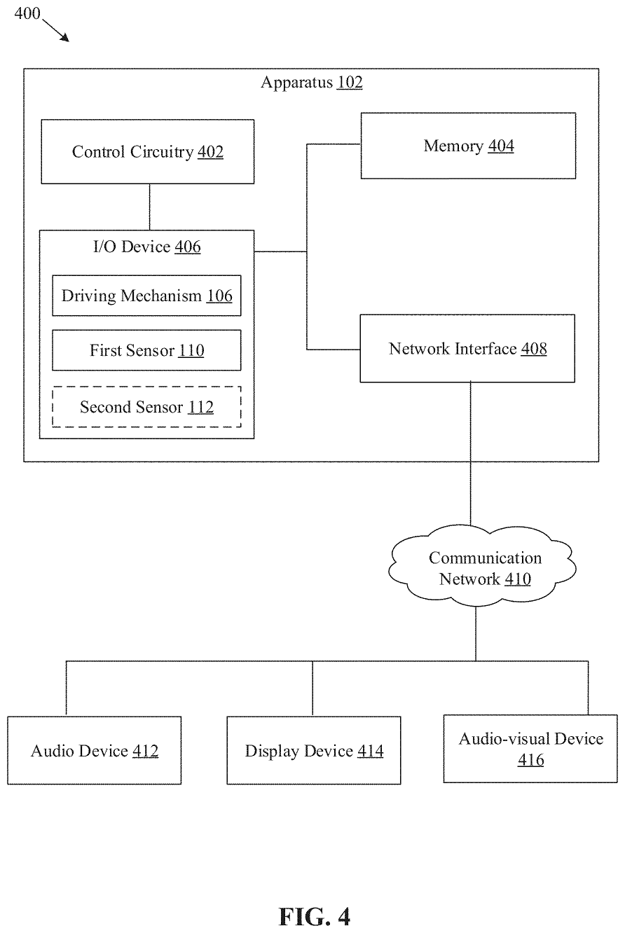

In an embodiment, the apparatus 202 may be further configured to generate a notification signal upon an installation of each article on a respective section of the plurality of first receiving sections 210. For example, the notification signal may be generated based on a movement of each actuator of the plurality of actuators 206A from the “D2” position (i.e., the first position as shown in FIG. 3B) to the “D3” position (i.e., the second position as shown in FIG. 3B). Examples of the notification may include at least one of: an audible notification (such as a click sound, an alarm, etc.), a visual notification (such as via a display unit associated with the apparatus 102), or an audio-visual notification. Details of such notifications are further described, for example, in FIG. 4.

As the apparatus 202 is spread across one or more locations, such as the first station 204 and the second station 206 of the assembly line, corresponding operations performed by the apparatus 202 may be spread across the first station 204 and the second station 206. For example, the apparatus 202 performs the determination of height and the computation of the offset values for each section of the plurality of first receiving sections 210 at the first station 204. Thereafter, the apparatus 202 performs the installation of each article of the plurality of articles 206B on a respective section of the plurality of first receiving sections 210 at the second station 206. As the apparatus splits operations between two stations (such as the first station 204 and the second station 206), the cycle time (such as a time that may be required to couple each article of the plurality of articles 206B with a respective section of the plurality of first receiving sections 210) associated with the installation of each article of the plurality of articles 206B may be minimum or below a set threshold.

FIGS. 3A-3B are diagrams that collectively illustrate exemplary operations of the apparatus of FIG. 1, in accordance with an embodiment of the disclosure. FIGS. 3A-3B are explained in conjunction with elements from FIGS. 1, 2A, and 2B. With reference to FIGS. 3A-3B, there is shown an exemplary block diagram 300 that includes a set of operations of the apparatus 102. The set of operations may include a component detection operation 302A, a height determination and offset computation operation 302B, an actuation operation 302C, and an installation operation 302D.

In an embodiment, prior to the execution of the set of operations 302A-302D, it may be necessary to calibrate the apparatus 102. In an embodiment, the apparatus 102 may calibrate at least one of: the first sensor 110 or the actuator 108 to the default values of position/orientation, based on a preset master value stored on the apparatus 102.

In the component detection operation 302A, the apparatus 102 may control a detection element 304A associated with the first sensor 110, to detect an identification element 304B associated with the first component 118. Based on the detection of the identification element 304B, the apparatus 102 may be configured to detect a presence of the first component 118 within a workspace of the apparatus 102. In an embodiment, the detection element 304A may include suitable logic, circuitry, and interfaces that may be configured to detect the presence of the first component 118. For example, when the first component 118 enters the workspace 102A of the apparatus 102, the detection element 304A may be configured to detect the presence of the first component 118.

In an embodiment, the detection element 304A may be a radio-frequency identification (RFID) scanner and the identification element 304B may be a radio-frequency identification (RFID) tag. The RFID scanner may scan the workspace 102A to detect the RFID tag associated with the first component 118 to determine the presence of the first component 118 within the workspace 102A of the apparatus 102. Examples of the RFID tag may include, but are not limited to, an active RFID or a passive RFID tag. In an embodiment, the detection element 304A may be a different scanner, such as an optical sensor, an acoustic sensor, or an image sensor. The detection element 304A may be disposed on the support structure or at any other location, such as, but not limited to, a part of the actuation cylinder 106A, a part of the actuator 108, or an external structure in proximity of the apparatus 102.

In an embodiment, the identification element 304B may transmit data associated with the first component 118 to the detection element 304A. For example, the transmitted data may include a part ID or a component ID associated with the first component 118. In case the detection element is an image sensor, then the identification element 304B may be a printed code, such as a barcode or a QR code. The detection element 304A may read the identification element 304B associated with the first component 118 to detect the first component 118 within the workspace 102A. Upon detection of the first component 118, the apparatus 102 may execute the height determination and offset computation operation 302B.

In the height determination and offset computation operation 302B, the apparatus 102 may control the first sensor 110 to determine the first height 116A of the first receiving section 116 with respect to the datum 118B of the first component 118. For example, the apparatus 102 may determine the first height 116A that may be a measurement of a distance from the datum 118B of the first component 118 to a tip of the first receiving section 116. In an embodiment, the first sensor 110 may be an optical sensor that may be configured to detect the measurement of the distance from the datum 118B of the first component 118 to the tip of the first receiving section 116.

Based on the determination of the first height 116A, the apparatus 102 may compute an offset distance 306 (as shown in the actuation operation 302C) with respect to the determined first height 116A of the first receiving section 116. In an embodiment, the apparatus 102 may compare information associated with the determined first height 116A of the first receiving section 116 of the first component 118, with information associated with a default height of the first receiving section 116, which may be stored as the preset master value on the apparatus 102. Based on the comparison, the apparatus 102 may compute the offset distance 306 for the first receiving section 116 of the first component 118. An example of a comparison between the information associated with the first height 116A of the first receiving section 116 and the information associated with the corresponding default height is presented in Table 2, as follows:

TABLE 2
Computation of the offset distance

| | |
|---|---|
| Default Height Value (in mm) | 101.1 |
| Determined Height Value (in mm) | 101.3 |
| Computed Offset Distance (in mm) | −0.2 |

In Table 2, the default height value may be 101.1 mm, which may be stored on the apparatus 102. The determined first height 116A may be 101.3 mm, which may be measured from the datum 118B of the first component 118 to the tip of the first receiving section 116. In an embodiment, the offset distance 306 may be a difference between the default height and the determined first height 116A. As an example, if the determined first height 116A is 101.3 mm and the default height is 101.1 mm, then the computed offset distance 306 is −0.2 mm (which is the difference between 101.3 and 101.1 mm). Based on the computation of the offset distance 306 with respect to the determined first height 116A of the first receiving section 116, the apparatus 102 may actuate the driving mechanism 106, as described herein.

In the actuation operation 302C, the apparatus 102 may move the actuator 108 at a first position 308A in proximity of the first receiving section 116, based on the computed offset distance 306 and the determined first height 116A. In an embodiment, the driving mechanism 106 may be actuated to move the actuator 108 to the first position 308A such that the first position 308A of the actuator 108 may be at the offset distance 306 from the determined first height 116A of the first receiving section 116

In an embodiment, the actuator 108 may extend vertically from the actuation cylinder 106A of the driving mechanism 106 to reach the first position 308A, as shown in FIG. 3B. In another embodiment, the actuator 108 may extend horizontally (not shown) from the actuation cylinder 106A of the driving mechanism 106 to reach the first position 308A. In another embodiment, the actuator 108 may extend angularly (not shown) from the actuation cylinder 106A of the driving mechanism 106, to reach the first position 308A. Such implementations may be selected based on a position of the detected first component 118.

In the installation operation 302D, the actuation of the driving mechanism 106 may further displace the actuator 108 from the first position 308A to a second position 308B. The displacement may cause the actuator 108 to apply a force on the article 114. The application of the force may cause the article 114 to mate or couple with the first receiving section 116. Based on the movement of the actuator 108 from the first position 308A to the second position 308B, the apparatus 102 may control the second sensor 112 to measure the force that may be applied on the article 114. Based on the measured force, the apparatus 102 may determine whether the article 114 correctly mates with the first receiving section 116. For example, the measured force may be plotted against a displacement of the actuator 108 (as shown in the graph 212 of FIG. 2B) to determine whether the article 114 correctly mates with the first receiving section 116 and to diagnose any installation errors (if encountered).

From the graph 212, the apparatus 102 may determine an optimal installation force to be applied on the article 114 to couple or mate with the first receiving section 116. The apparatus 102 may utilize such a measurement to also determine whether the article 114 correctly mates with the first receiving section 116 as per quality requirements. For example, the quality requirements may relate to a standard checklist that may be stored on the apparatus 102. Based on the stored checklist, the apparatus 102 may configure the actuator 108 to precisely mate or couple the article 114 with the first receiving section 116.

In an embodiment, based on the movement of the actuator 108 from the first position 308A to the second position 308B, the apparatus 102 may be further configured to store a status on the identification element 304B (i.e., the Radio Frequency Identification (RFID) tag) coupled to the first component 118. The status may be indicative of whether the article 114 correctly mates with the first receiving section 116. The status may further include information associated with the installation of the article 114. The information may include, for example, a message (such as “Successfully Installed”) that may be indicative of a successful installation of the article 114 on the first receiving section 116. As another example, the information may include a message (such as “Abnormality detected in the first section of the plurality of first receiving sections”) that may indicate an unsuccessful installation of the article 114 on the first receiving section 116. Based on the status of the identification element 304B, the apparatus 102 may be configured to execute an action (such as to control a conveyer belt (not shown) associated with the first component 118 to move the first component 118) for further analysis and to determine a cause of abnormality or fault in the installation. The action may also include an operation to raise an alarm, which may indicate an abnormality or fault in the installation.

In case of the successful installation of the article 114 on the first receiving section 116, the apparatus 102 may configure the conveyer belt to move the first component 118 to an inventory station (such as a station that may be configured to store finished products). In case of unsuccessful installation, the apparatus 102 may configure the conveyer belt to move the first component 118 to a troubleshooting station (such as a station that may be configured to troubleshoot or repair faulty article installations).

FIG. 4 is a block diagram of an exemplary apparatus for pressing articles on components of a vehicle assembly, in accordance with an embodiment of the disclosure. FIG. 4 is explained in conjunction with elements from FIGS. 1, 2A, 2B, and 3A-3B. With reference to FIG. 4, there is shown a block diagram 400 of the apparatus 102. In an embodiment, the block diagram 400 may be also applicable to the apparatus 202. The apparatus 102 may include control circuitry 402, a memory 404, a I/O device 406, a network interface 408, and a communication network 410. The apparatus 102 may be configured to couple the apparatus 102 with at least one of: an audio device 412, a display device 414, or an audio-visual device 416, via the communication network 410, to transmit the notification that may be associated with the installation of the article 114 on the first receiving section 116 of the first component 118.

The control circuitry 402 may include suitable logic, circuitry, and/or interfaces that may be configured to execute program instructions associated with different operations to be executed by the apparatus 102. For example, some of the operations may include, but are not limited to, detection of the first component 118 of the vehicle assembly within the workspace 102A of the apparatus 102, control of the first sensor 110 to determine the first height 116A of the first receiving section 116 with respect to the datum 118B of the first component 118, computation of the offset distance 306 with respect to the determined first height 116A of the first receiving section 116, and actuation of the driving mechanism 106 based on the computed offset distance 306 and the determined first height 116A. The execution of operations is further described, for example, in FIGS. 3A-3B.

The control circuitry 402 may include any suitable special-purpose or general-purpose computer, computing entity, or processing device including various computer hardware or software modules and may be configured to execute instructions stored on any applicable computer-readable storage media (for example, the memory 404). The control circuitry 402 may be implemented based on several processor technologies known in the art. For example, the control circuitry 402 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. The control circuitry 402 may include any number of processors that may be configured to, individually or collectively, perform any number of operations of the apparatus 102, as described in the present disclosure. Examples of the apparatus 102 may include a Central Processing Unit (CPU), a Graphical Processing Unit (GPU), an x86-based processor, an x64-based processor, a Reduced Instruction Set Computing (RISC) processor, a Complex Instruction Set Computing (CISC) processor, and/or other hardware processors.

The memory 404 may include suitable logic, circuitry, interfaces, and/or code that may be configured to store the set of instructions executable by the control circuitry 402. In an embodiment, the memory 404 may be configured to store information associated with the detection of the first component 118, information associated with the first height 116A of the first receiving section 116 with respect to the datum 1186 of the first component 118, information associated with the offset distance, information associated with the movement (such as the first position and the second position) of the actuator 108, information associated with the measured force, and information associated with the notification from the apparatus 102. Examples of implementation of the memory 404 may include, but are not limited to, Random Access Memory (RAM), Read Only Memory (ROM), Hard Disk Drive (HDD), a Solid-State Drive (SSD), a CPU cache, and/or a Secure Digital (SD) card.

The I/O device 406 may include suitable logic, circuitry, interfaces, and/or code that may be configured to receive user inputs (for example, via the first sensor 110 and the second sensor 112) and may render output (for example, via the driving mechanism 106, the audio device 412, the display device 414, or the audio-visual device 416) in response to the received user inputs. In an embodiment, the I/O device 406 may be integrally coupled to the apparatus 102 to receive the user inputs and may render output (for example, via the driving mechanism 106, the audio device 412, the display device 414, or the audio-visual device 416) in response to the received user inputs. In another embodiment, the I/O device 406 may be communicably coupled to the apparatus 102 to receive the user inputs, via the communication network 410. In some embodiments, the I/O device 406 may include the driving mechanism 106, the first sensor 110, and the second sensor 112. In other embodiment, the I/O device 406 may include various input and output devices that may be configured to communicate with the control circuitry 402. Examples of the such input and output devices may include, but are not limited to, a touch screen, a touch pad, a keyboard, a mouse, a joystick, a microphone, a display device, a speaker, an infotainment system, or an image sensor.

The network interface 408 may include suitable logic, circuitry, and interfaces that may be configured to facilitate communication between the control circuitry 402 and external devices, via the communication network 410. The network interface 408 may be implemented by use of various technologies to support wired or wireless communication of the apparatus 102 with the communication network 410. The network interface 408 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 408 may be configured to communicate via wireless communication with networks, such as the Internet, an Intranet or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The communication network 410 may include a communication medium through which the apparatus 102 and at least one of: the audio device 412, the display device 414, or the audio-visual device 416 may communicate with each other. The communication network 410 may be one of a wired connection or a wireless connection. Examples of the communication network 410 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in a network environment of the apparatus 102 may be configured to connect to the communication network 410 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The audio device 412 may include suitable logic, circuitry, and interfaces that may be configured to transmit the notification to the operator, based on the installation of the article 114 on the first receiving section 116 of the first component 118. In an embodiment, the audio device 412 may be configured to control playback of an audio output, based on the installation of the article 114 on the first receiving section 116 of the first component 118. The audio device 412 may be configured to receive electrical audio signals from the control circuitry 402 and convert the received electrical audio signals into the audio/sound output. In an embodiment, the audio device 412 may be communicably coupled to the apparatus 102, via the communication network 410. In another embodiment, the audio device 412 may be integrally formed in the apparatus 102, as the I/O device 406. Examples of the audio device 412 may include, but are not limited to, a loudspeaker, a woofer, a sub-woofer, a tweeter, a wireless speaker, a wired speaker, a soundcard, a headphone, or other speakers or sound output device.

The display device 414 may include suitable logic, circuitry, and interfaces that may be configured to display the notification (such as the installation status) to the operator, based on the installation of the article 114 on the first receiving section 116 of the first component 118. The display device 414 may be a touch screen, which may enable a user to provide a user-input via the display device 414. The touch screen may be at least one of a resistive touch screen, a capacitive touch screen, or a thermal touch screen. In an embodiment, the display device 414 may be communicably coupled to the apparatus 102, via the communication network 410. In another embodiment, the display device 414 may be integrally formed in the apparatus 102, as the I/O device 406. Examples of the display device 414 may include, but not limited to, at least one of: a liquid crystal display (LCD) display, a Light Emitting Diode (LED) display, a plasma display, or an Organic LED (OLED) display technology, or other display devices. In accordance with an embodiment, the display device 414 may refer to a display screen of a head-mounted device (HMD), a smart-glass device, a see-through display, a projection-based display, an electro-chromic display, or a transparent display.

The audio-visual device 416 may be an infotainment system that may be configured to transmit the notification to the operator, based on the installation of the article 114 on the first receiving section 116 of the first component 118. In an embodiment, the audio-visual device 416 may be a combination of the audio device 412 and the display device 414. For example, the audio-visual device 416 may be a human machine interface (HMI) in the assembly line, which may be configured to transmit the notification to the operator, via a display unit (such as the display screen) and an integral audio device (such as a speaker) of the display unit.

In operations, the control circuitry 402 may control the detection element 304A to detect a presence of the first component 118 of the vehicle assembly within the workspace 102A of the apparatus 102. Based on the detection of the first component 118, the control circuitry 402 may further control the first sensor 110 to determine the first height 116A of the first receiving section 116 with respect to the datum 118B of the first component 118. Based on the determined first height 116A, the control circuitry 402 may compute the offset distance 306 with respect to the determined first height 116A of the first receiving section 116. Based on the computed offset distance 306, the control circuitry 402 may actuate the driving mechanism 106 based on the computed offset distance 306 and the determined first height 116A. The actuation of the driving mechanism 106 may displace the actuator 108 from the first position 308A to the second position 308B. The displacement may cause the actuator 108 to apply a force on the article 114. The application of the force may cause the article 114 to mate or couple with the first receiving section 116.

Based on the movement of the actuator 108 from the first position 308A to the second position 308B, the control circuitry 402 may control the second sensor 112 to measure the force that may be applied on the article 114. Based on the measured force, the control circuitry 402 may collect a set of datapoints which may relate to the displacement of the actuator 108 from the first position 308A to the second position 308B with variations in the measured force that may be applied on the article 114. The set of datapoints may include, for example, numerical values that may be used to plot the measured speed curve 212A, the measured force curve 212B, and the threshold force curve 212C of the graph 212. Based on the collected set of datapoints, the control circuitry 402 may compare the collected set of datapoints with the pre-stored set of datapoints (in the memory 404). Based on the comparison, the control circuitry 402 may further determine whether the article 114 may correctly mates with the first receiving section 116.

In an embodiment, based on the installation of the article 114 with the first receiving section 116, the control circuitry 402 may be further configured to control one or more media devices (such as the audio device 412, the display device 414, or the audio-visual device 416) to output a notification as one of: an audible notification (such as an audio signal that may be transmitted via the audio device 412), a visual notification (such as a visual indication that may be transmitted via at least one of: a lighting system, or the display device 414), or an audio-visual notification (such as a notification via an infotainment system). In an embodiment, the. output notification may be indicative of whether the article 114 correctly mates with the first receiving section 116.

In another embodiment, the control circuitry 402 may further collect information that may include one or more of: the detection of the first component 118, the determined first height 116A, the computed offset distance (as shown in FIGS. 3A-3B), the force applied on the article 114, the movement of the actuator 108 to the first position, and the displacement from the first position to the second position (as shown in FIGS. 3A-3B). Based on the collected information, the control circuitry 402 may control one or more media devices (such as the audio device 412, the display device 414, or the audio-visual device 416) to display the collected information as a notification for an operator regarding the collected information. The notification may include at least one of: an audible notification (such as an audio signal that may be transmitted via the audio device 412), a visual notification (such as a visual indication that may be transmitted via at least one of: the lighting system, or the display device 414), or an audio-visual notification.

A person of ordinary skill in the art will understand that the apparatus 102 may also include other suitable components or systems, in addition to the components or systems which are illustrated. A detailed description for the other components or systems of the has been omitted from the disclosure for the sake of brevity. The present disclosure may be realized in hardware, or a combination of hardware and software. The present disclosure may be realized in a centralized fashion, in at least one computer system, or in a distributed fashion, where different elements may be spread across several interconnected computer systems. The functions or operations executed by the apparatus 102 and/or the apparatus 202, as described in corresponding FIGS. 1, 2A-2B, 3A-3B, may be performed by the control circuitry 402.

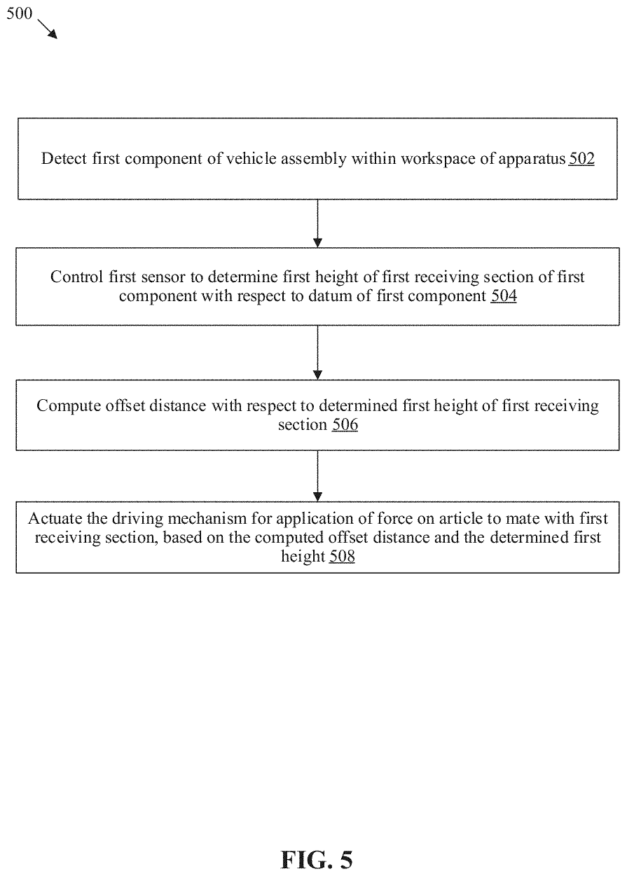

FIG. 5 is a flowchart that illustrates a first exemplary method to couple an article with a receiving section of a component, in accordance with an embodiment of the disclosure. FIG. 5 is explained in conjunction with elements from FIGS. 1, 2, 3A-3B, and 4. With reference to FIG. 5, there is shown a flowchart 500 that depicts a first exemplary method to couple the article 114 with the first receiving section 116 of the first component 118. The method illustrated in the flowchart 500 may start from 502.

At 502, the first component 118 of the vehicle assembly may be detected within the workspace 102A of the apparatus 102. In an embodiment, the detection element 304A (or the control circuitry 402) of the apparatus 102 may be configured to detect the first component 118, as described, for example, in FIG. 3A.

At 504, the first height 116A of the first receiving section 116 of the first component 118 with respect to the datum 118B of the first component 118 may be determined. In an embodiment, the control circuitry 402 may be configured to control the first sensor 110 of the apparatus 102 to determine the first height 116A of the first receiving section 116 of the first component 118 with respect to the datum 118B of the first component 118, as described, for example, in FIG. 3A.

At 506, the offset distance 306 may be computed with respect to the determined first height 116A of first receiving section 116. In an embodiment, the control circuitry 402 may be configured to compute the offset distance 306 with respect to determined first height 116A of first receiving section 116, as described, for example, in FIG. 3B.

At 508, the driving mechanism 106 may be actuated, based on the computed offset distance 306 and the determined first height 116A. Based on the actuation of the driving mechanism 106, the actuator 108 may be moved and displaced, for the application of the force on the article 114. The application of the force may mate the article 114 with first receiving section 116. In an embodiment, the control circuitry 402 may actuate the driving mechanism 106, based on the computed offset distance 306 and the determined first height 116A. Based on the actuation of the driving mechanism 106, the control circuitry 402 may move and displace the actuator 108, for the application of a force (i.e. a pressing force) on the article 114 so as to mate or couple the article 114 with the first receiving section 116, as described, for example, in FIG. 3B. The control may pass to end.

The flowchart 500 is illustrated as discrete operations, such as 502, 504, 506, and 508. However, in certain embodiments, such discrete operations may be further divided into additional operations, combined into fewer operations, or eliminated, or rearranged depending on the implementation without detracting from the essence of the disclosed embodiments.

Various embodiments of the disclosure may provide a non-transitory, computer-readable medium and/or storage medium, and/or a non-transitory machine readable medium and/or storage medium stored thereon, a set of instructions executable by a machine and/or a computer (for example the apparatus 102) to couple the article 114 with the first receiving section 116 of the first component 118. The set of instructions may be executable by the machine and/or the computer (for example, the apparatus 102) to perform operations that may include, but are not limited to, detection of the first component 118 of the vehicle assembly within the workspace 102A of the apparatus 102, control of the first sensor 110 to determine the first height 116A of the first receiving section 116 with respect to the datum 118B of the first component 118, computation of the offset distance (as shown in FIGS. 3A-3B) with respect to the determined first height 116A of the first receiving section 116, actuation of the driving mechanism 106, which may move the actuator 108 at the first position (as shown in FIG. 3B) in proximity of the first receiving section 116, based on the computed offset distance and the determined first height 116A, and displacement of the actuator 108 from the first position to the second position, which may cause the actuator 108 to apply the force on the article 114, to mate with the first receiving section 116. The execution of operations may be further described, for example, in FIGS. 3A-3B.

For the purposes of the present disclosure, expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural. Further, all joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

The foregoing description of embodiments and examples has been presented for purposes of illustration and description. It is not intended to be exhaustive or limiting to the forms described. Numerous modifications are possible considering the above teachings. Some of those modifications have been discussed and others will be understood by those skilled in the art. The embodiments were chosen and described for illustration of various embodiments. The scope is, of course, not limited to the examples or embodiments set forth herein but can be employed in any number of applications and equivalent devices by those of ordinary skill in the art. Rather it is hereby intended the scope be defined by the claims appended hereto. Additionally, the features of various implementing embodiments may be combined to form further embodiments.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a situation or material to the teachings of the present disclosure without departing from its scope. Therefore, it is intended that the present disclosure is not limited to the embodiment disclosed, but that the present disclosure will include all embodiments that fall within the scope of the appended claims.

What is claimed is:

1. An apparatus, comprising:
a support fixture;
a driving mechanism that is coupled to the support fixture and comprises an actuator;
a first sensor coupled to the support fixture; and
control circuitry which:
detects a first component of a vehicle assembly within a workspace of the apparatus, wherein the first component comprises at least a first receiving section;
controls the first sensor to determine a first height of the first receiving section with respect to a datum of the first component, based on the detection;
computes an offset distance with respect to the determined first height of the first receiving section; and
actuates the driving mechanism to:
move the actuator at a first position in proximity of the first receiving section, based on the computed offset distance and the determined first height; and
displace the actuator from the first position to a second position,
wherein the displacement causes the actuator to apply a force on an article, and
wherein the application of the force causes the article to mate with the first receiving section.

2. The apparatus according to claim 1, further comprising a second sensor coupled to the actuator,
wherein the control circuitry controls the second sensor to measure the force applied on the article based on the movement of the actuator from the first position to the second position.

3. The apparatus according to claim 2, wherein the control circuitry:
collects a set of datapoints which relate the displacement from the first position to the second position with variations in the measured force applied on the article;
compares the collected set of datapoints with a pre-stored set of datapoints; and
determines whether the article correctly mates with the first receiving section, based on the comparison.

4. The apparatus according to claim 3, wherein the control circuitry stores a status in a Radio Frequency Identification (RFID) tag coupled to the first component, and
wherein the status is indicative of whether the article correctly mates with the first receiving section.

5. The apparatus according to claim 3, wherein the control circuitry controls one or more media devices to output a notification as one of: an audible notification, a visual notification, or an audio-visual notification, and
wherein the. output notification is indicative of whether the article correctly mates with the first receiving section.

6. The apparatus according to claim 1, wherein the control circuitry collects information that comprises one or more of: the detection of the first component, the determined first height, the computed offset distance, the force applied on the article, the movement of the actuator to the first position, and the displacement from the first position to the second position.

7. The apparatus according to claim 6, wherein the control circuitry controls one or more media devices to display the collected information.

8. The apparatus according to claim 1, wherein the control circuitry reads a radio-frequency identification (RFID) tag associated with the first component to detect the first component within the workspace.

9. The apparatus according to claim 8, wherein the control circuitry stores the computed offset distance to the RFID tag associated with the first component.

10. The apparatus according to claim 1, wherein the article is disposed on the actuator or the first receiving section of the first component.

11. The apparatus according to claim 1, wherein the article is one of: a valve seal, a camshaft seal, a crankshaft seal, a B-cap, an injector rail, or a body bushing for a frame of the vehicle assembly.

12. The apparatus according to claim 1, wherein the first component is an engine head.

13. The apparatus according to claim 1, wherein the first receiving section is one of: a valve guide, a cam shaft, or a crank shaft.

14. A method, comprising:
detecting a first component of a vehicle assembly within a workspace of an apparatus, which comprises:
a support fixture;
a driving mechanism that is coupled to the support fixture and comprises an actuator; and
a first sensor coupled to the support fixture;
controlling the first sensor to determine a first height of a first receiving section of the first component with respect to a datum of the first component, based on the detection;
computing an offset distance with respect to the determined first height of the first receiving section; and
actuating the driving mechanism to:
move the actuator at a first position in proximity of the first receiving section, based on the computed offset distance and the determined first height; and
displace the actuator from the first position to a second position,
wherein the displacement causes the actuator to apply a force on an article, and
wherein the application of the force causes the article to mate with the first receiving section.

15. The method according to claim 14, further comprising controlling a second sensor coupled to the actuator to measure the force applied on the article based on the movement of the actuator from the first position to the second position.

16. The method according to claim 15, further comprising:
collecting a set of datapoints which relate the displacement from the first position to the second position with variations in the measured force applied on the article;
comparing the collected set of datapoints with a pre-stored set of datapoints; and
detecting whether the article correctly mates with the first receiving section, based on the comparison.

17. The method according to claim 16, further comprising storing a status in a Radio Frequency Identification (RFID) tag coupled to the first component, and
wherein the status is indicative of whether the article correctly mates with the first receiving section.

18. The method according to claim 16, further comprising controlling one or more media devices to output a notification as one of an audible notification, a visual notification, or an audio-visual notification, and
wherein the. output notification is indicative of whether the article correctly mates with the first receiving section.

19. The method according to claim 14, further comprising:
collecting information that comprises one or more of: the detection of the first component, the determined first height, the computed offset distance, the force applied on the article, the movement of the actuator to the first position, and the displacement from the first position to the second position; and
controlling one or more media devices to display the collected information.

20. A method, comprising:
detecting a first component of a vehicle assembly;
controlling a first sensor to determine a first height of a first receiving section of the first component with respect to a datum of the first component, based on the detection;
computing an offset distance with respect to the determined first height of the first receiving section; and
actuating a driving mechanism comprising an actuator, wherein the driving mechanism is actuated to:
move the actuator at a first position in proximity of the first receiving section, based on the computed offset distance and the determined first height; and
displace the actuator from the first position to a second position,
wherein the displacement causes the actuator to apply a force on an article, and
wherein the application of the force causes the article to mate with the first receiving section.
